(19) United States
(12) Patent Application Publication
(10) Pub. No.: US 2002/0183869 A1
(43) Pub. Date: Dec. 5, 2002

(54) Using fault tolerance mechanisms to adapt to elevated temperature conditions

(76) Inventors: David Chaiken, Menlo Park, CA (US); Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/834,525

(22) Filed: Apr. 12, 2001

(51) Int. Cl. G05B 9/02

(52) U.S. Cl. 700/79; 700/299; 713/300

(57) ABSTRACT

A system is disclosed that gracefully degrades system performance at elevated temperatures, for example by shutting down individual components of the system. In the presently preferred embodiment of the invention, when a marginal temperature condition is detected, a computer can conserve power, and thereby reduce heat generation, by intentionally slowing or shutting down individual components. A marginal temperature condition occurs when the temperature sensors detect an ambient temperature that is close to exceeding the operating range and rising. This temperature adaptation technique allows the computer to continue to function at elevated temperatures, albeit at a lower performance level than it would in its ordinary operating environment. It is also possible to shut down the computer to a minimal level of activity to allow for uninterrupted remote diagnostics and commands, as opposed to continuing service to consumers.

### BACKGROUND OF THE INVENTION

1. Technical Field

The invention relates to maintaining an acceptable temperature range within which a computer system may be operated. More particularly, the invention relates to using fault tolerance mechanisms to adapt the operation of a computer system to elevated temperature conditions.

2. Description of the Prior Art

High performance computers require a moderate temperature environment, e.g. 0-40 degrees Celsius, to operate properly. Computers that require moderate temperatures are typically installed in special purpose rooms or offices with adequate air conditioning to maintain acceptable temperatures. Heating is also sometimes required.

Expensive computing equipment normally comes equipped with temperature sensors that allow the equipment to be shut down completely when the temperature exceeds an acceptable range, thus avoiding damage to the computer.

A system developed by AgileTV of Menlo Park, Calif. comprises a computing engine that is installed, and that must operated, in regional cable television distribution installations, referred to herein as head-ends. Unfortunately, many head-ends are built for modulation equipment, rather than high performance computers. As a result, the head-end environment sometimes exceeds acceptable temperature ranges for such high performance computers.

A variety of situations might result in an unacceptable temperature level. Some situations, e.g. complete air conditioning failure, inadequate air conditioning, or insufficient air flow, result in slowly rising and marginal temperatures.

It is known to slow components to reduce power and heat in a computer system. It is also known to shut down a system when temperature thresholds are exceeded. It would be desirable to provide a system that gracefully degrades system performance at elevated temperatures, for example by shutting down individual components of the system.

### SUMMARY OF THE INVENTION

The invention provides a system that gracefully degrades system performance at elevated temperatures, for example by shutting down individual components of the system. In the presently preferred embodiment of the invention, when a marginal temperature condition is detected, a computer can conserve power, and thereby reduce heat generation, by intentionally slowing or shutting down individual components. A marginal temperature condition occurs when the temperature sensors detect an ambient temperature that is close to exceeding the operating range and rising. This temperature adaptation technique allows the computer to continue to function at elevated temperatures, albeit at a lower performance level than it would in its ordinary operating environment. It is also possible to shut down the computer to a minimal level of activity to allow for uninterrupted remote diagnostics and commands, as opposed to continuing service to consumers.

### BRIEF DESCRIPTION OF THE DRAWINGS

FIG. 1 is a block schematic diagram of a fault tolerant, multiprocessor architecture according to the invention;

FIG. 2 is a block schematic diagram of a processor array according to the invention; and

FIG. 3 is a block schematic diagram of an system operator console showing a temperature sensor according to the invention.

### DETAILED DESCRIPTION OF THE INVENTION

The invention provides a system that gracefully degrades system performance at elevated temperatures, for example by shutting down individual components of the system.

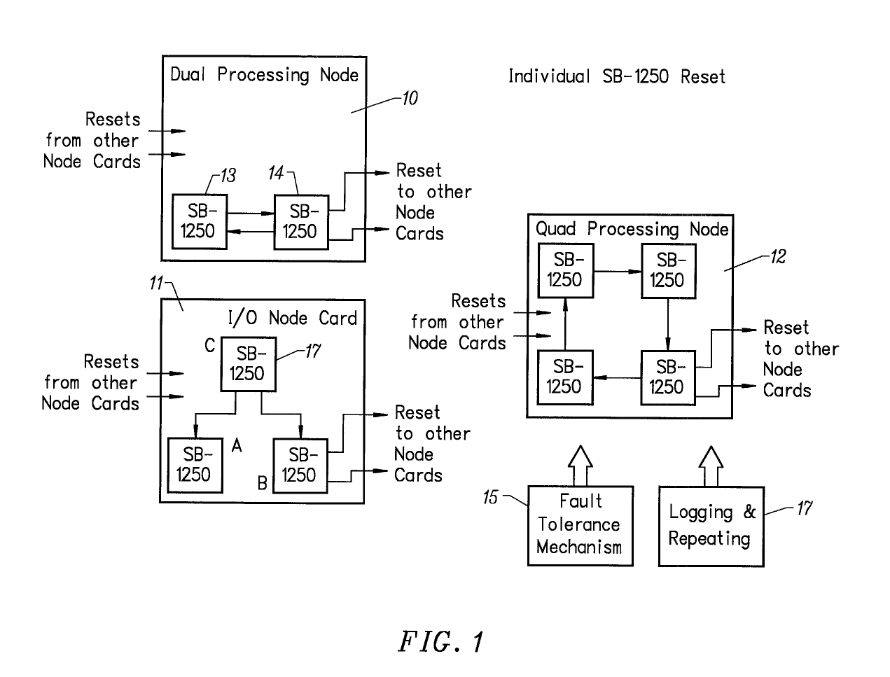

FIG. 1 is a block schematic diagram of a fault tolerant, multiprocessor architecture according to the invention. FIG. 1 shows a plurality of nodes 10, 11, 12 each of which comprises two or more processors, e.g. the node 10 comprises the processors 13, 14.

Each node includes both internal reset mechanisms and a reset pathway with one or more other nodes. The following fault tolerance mechanisms 15 of computers systems, such as those present in the AgileTV architecture (AgileTV, Menlo Park, Calif.), allow them to continue functioning when individual chips, printed circuit boards, network links, fans, or power supplies fail (see, for example, [inventor, title] U.S. patent application Ser. No. [ ], filed [ ], attorney docket no. AGLE0025):

Multiple processors having self contained operating systems;

Redundant network links;

Redundant power supplies;

Redundant links to input/output devices;

Distributed reset capability; and

Software fault detection, adaptation, and recovery algorithms.

These fault tolerance mechanisms also allow such computers to continue functioning when components thereof are intentionally shut down. Those skilled in the art will appreciate that other fault tolerant processing schemes may also be implemented in connection with the invention herein disclosed.

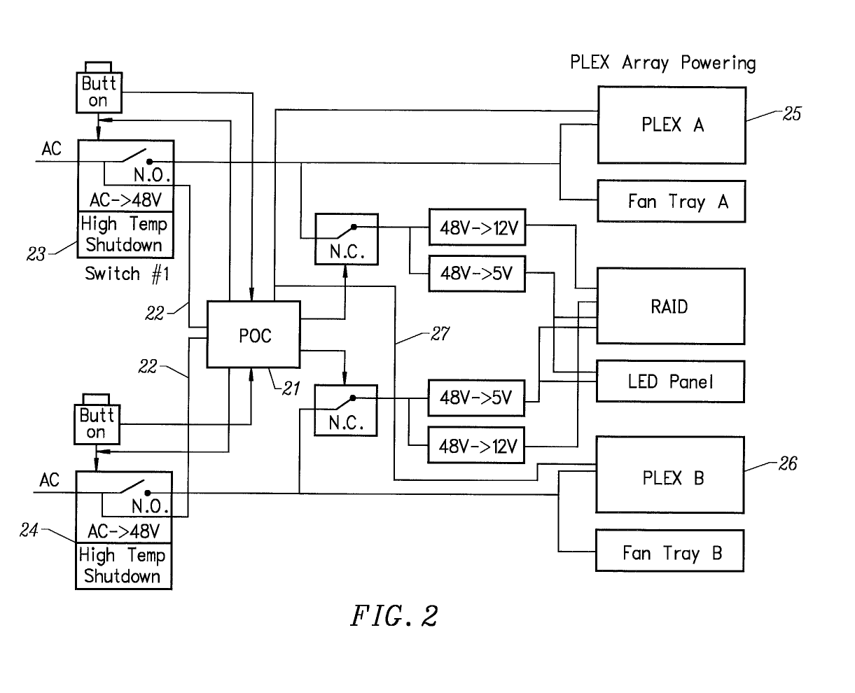

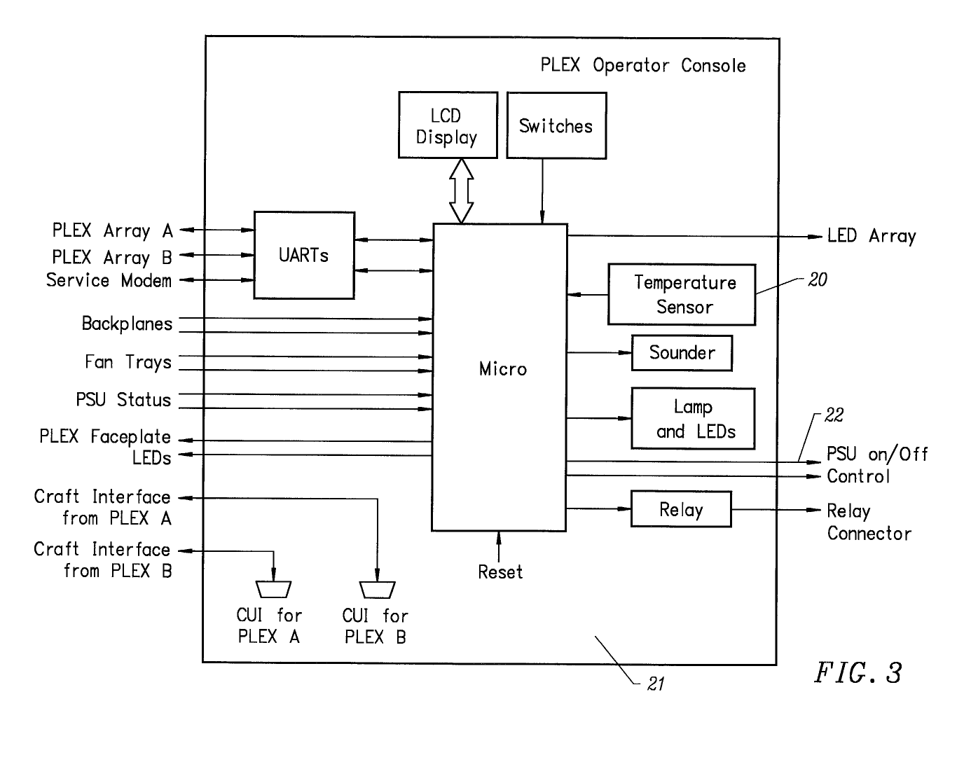

FIG. 2 is a block schematic diagram of a processor array according to the invention; and FIG. 3 is a block schematic diagram of an system operator console showing a temperature sensor according to the invention. In the presently preferred embodiment of the invention, when the computer detects a marginal temperature condition, e.g. with a temperature sensor 20, the computer can conserve power, and thereby reduce heat generation, by intentionally slowing or shutting down individual components. For example, the processor 21 can issue a control signal 22 to the power supplies 23, 24 for a computer element, such as an engine 25, 26 or at any other level of integration, e.g. a node or a processor, thereby shutting down one or more of the power supplies to such computing element. This partial shutdown reduces heat generation, for example, within a head end, and thereby mitigates stress to the system caused by extremes in ambient temperature.

A marginal temperature condition occurs when the temperature sensors detect an ambient temperature that is close to exceeding the operating range, and (optionally) that is rising. This temperature adaptation technique allows the computer to continue to function at elevated temperatures, albeit at a lower performance level than it would in its ordinary operating environment. It is also possible to shut down the computer to a minimal level of activity to allow for uninterrupted remote diagnostics and commands, as opposed to continuing service to consumers.

For purposes of the discussion herein, slowing components means reducing the clock rate on individual chips or printed circuit boards. Examples of clock rate reduction include lowering the speed of external modulators, selecting alternate and slower oscillators, or selecting a lower speed via programmable, on chip phase-locked loops. It is also possible, in some cases, to operate a chip at lower voltages after reducing the clock rate. Processor speed may be controlled via, for example, a control line 27, while voltage levels may be controlled directly at the power supply for the affected processor. Thus, instead of turning a power supply off, the system selects a lower operating voltage using the same mechanism that is used to turn the supply off. In this way, the invention provides a technique that allows levels of performance reduction to be selected before a processing element is entirely shut down.

For purposes of the discussion herein, shutting down means stopping software from running on processors or removing power from components such as chips, printed circuit boards, network links, power supplies, backplanes, buses, or input/output devices.

FIGS. 2 and 3 show an example of a temperature mediation technique that is implemented within a system at the highest level of system control, e.g. at the engine (PLEX) level. Those skilled in the art will appreciate that the invention is readily applicable at all levels of system integration, e.g. at the node or individual processor level of integration. Thus, each node in an engine may shut down, slow, or reduce operating voltages in other nodes in that engine. and each processor in a node may likewise shut down, slow, or reduce operating voltages in other processors in that node.

The technique disclosed herein may be implemented exclusively in hardware, or as a combination of hardware and software. While hardware is used to slow or shut down components some systems, such as the AgileTV engine, operate more efficiently if software shuts down components in an orderly fashion. Orderly shutdown can include any of terminating software processes, flushing data to off-node memory or disks, removing chips from network routing tables, removing processors from job and object-manager tables, and notifying network operators of marginal temperature conditions and computer status.

In one embodiment of the invention, the computer operates in a temperature adaptation mode for a short interval of time, e.g. minutes, to extended periods of time, e.g. weeks or months. Adapting for several minutes or hours allows the computer to continue service during transient events, such as partial air conditioning failure. Working in temperature adaptation mode for weeks or months allows computer users, e.g. cable multiple system operators, to test and deploy the computer even when new air conditioning must ultimately be installed to maintain an appropriate operating environment, e.g. when full system use is achieved.

This invention leverages the fault tolerance mechanisms, multiple processing elements, and multiple input/output devices, found in a system, such as the AgileTV engine. In such systems, if one of the system components fails or loses functionality for some reason, such an internal failure is typically not visible to an external user because of the fault tolerant nature of the design. The invention exploits this fact to advantage by intentionally degrading the system, e.g. by slowing down processor speed or disconnecting system elements, to address such issues as environmental stress due to an ambient temperature which exceeds recommended operating temperatures of the system.

One problem addressed by the invention is being able to meet the needs of a few subscribers, e.g. of a cable television system, and to ramp up the number of subscribers in parallel, which justifies to the cable company that it is worth spending to install more air conditioning and putting in additional power. As the number of subscribers goes up, it is necessary to justify these expenses to the cable company, so that by the time there is a full load of subscribers there is also adequate air conditioning and adequate power to support the processing needs of such subscribers. A cable company does not want to have a low number of subscribers and yet have to meet high air conditioning and power requirements initially because the number of subscribers does not justify the excess (and idle) cooling and power capacity. The invention makes it possible to install a computer system that is engineered for the maximum number of subscribers. The system has the ability to detect the ambient temperature. For example, each of the processor cards includes a temperature detector. Thus, the system can monitor the ambient temperature and track how the temperature is changing with time.

In one embodiment of the invention, if the ambient temperature in a computer installation goes over a certain level, then because the invention comprehends a fault tolerant system, instead of the processors all failing and thereby shutting down the whole system due to overheating, the invention provides a mechanism that can shut down a number of the processors in the system. In one embodiment, the system software can shut down one or more processors, a node, or a printed circuit card, down to a state where it is drawing zero or very little power and therefore is contributing zero or very little to increasing the ambient temperature. This aspect of the invention is referred to herein as processing on demand.

In one embodiment, each card in the system has its own power supply. For example, in the AgileTV system there are 48 volts input to the system and 3.3 volts are output. One implementation of the invention allows the software to shut down the power supply. This approach is acceptable in arrangement where a node to be shut down does not have electrical connections to other nodes. Another implementation of the invention effectively shuts down the memory and executes a halt, a wait, or an instruction with a similar effect on power consumption by the processor. In this implementation, the processor effectively stops processing and the memory stops storing bits, thereby significantly reducing the system power requirements and heat generated by the system.

Another approach involves putting the processor into a state where it stops consuming power, but from which it can never recover. The processor just sits there waiting for an instruction that never happens. The only way to actually get that node running again (or that chip running again,) is to pull and release that line over which the instruction was asserted. This approach is useful where a processor does not have a mechanism for shutting it down to a low power mode. In such case, the processor is put into a low power, locked up state to reduce heat generation. In this embodiment, in systems that incorporate the fault tolerance mechanism discussed above, the system must be informed that a particular processor has been shut down. This should be done in an orderly fashion. One way to shut a processor down without disrupting system operation is to ask the processor to stop running any applications or transfer such functionality to a different processor if there are any jobs or applications running on the processor that are critical. For example, if system A was driving the disc memory and it was appropriate to shut down processor A to reduce heat generation, then processors A and B can communicate, and processor B can assume responsibility for the disc memory, after which processor A can safely shut itself down.

Another embodiment uses a restart mechanism in a processor, e.g. processor B, to turn off processor A. This approach works well because one of the things a restart requires is to take the power away from a processor and do a cold boot. In this embodiment, the system only performs half of the restart, i.e. turning the power off, it just does not turn the power back on.

Temperature and power throttling can be triggered either by the ambient temperature or by the current processing load, e.g. if the current processing load goes below a certain threshold the system can turn off resources and conserve energy.

The invention also provides a logging and reporting function 17 (see FIG. 1) that allows a system operator to know such information as if the system went over the maximum temperature at any point in time, or if subscriptions are up so that it is justified to buy another air conditioner, or it is justified to install another transformer to bring in more power.

The invention approaches the generic problem of fault tolerance in two completely different manners. There is both the centralized approach, as well as a decentralized approach. In the centralized approach, the control processor is responsible for issuing the above described actions and requests with regard to slowing or shutting down system resources. In the decentralized approach, there is no control processor per se controlling this aspect of the system. Rather, this is a distributed activity. A server farm is a good example of a decentralized approach.

Although the invention is described herein with reference to the preferred embodiment, one skilled in the art will readily appreciate that other applications may be substituted for those set forth herein without departing from the spirit and scope of the present invention.

Thus, while the discussion herein is concerned with sensing marginal ambient temperatures, those skilled in the art will appreciate that other environmental sensors may be employed in connection with the invention herein. For example, such sensors as moisture sensors, air pressure sensors, and the like may be used singly or in combination in conjunction with a fault tolerance mechanism to control system performance levels.

Further, the invention may be used in power failure and energy conservation applications.

Accordingly, the invention should only be limited by the Claims included below.

1. An apparatus for controlled degrading of system performance at marginal ambient temperatures, comprising:
a plurality of processing elements, each processing element in communication with at least one other processing element to effect a fault tolerant processing scheme;
a temperature sensor; and
a control mechanism responsive to said temperature sensor for any of slowing operation of, shutting down, or reducing power supplied to individual processing elements of said system in response to a marginal ambient temperature, as sensed by said temperature sensor;
wherein overall heat generated by said system is reduced.

2. The apparatus of claim 1, wherein said system comprises:
a plurality of nodes, each of which comprises two or more processors.

3. The apparatus of claim 2, wherein said control mechanism comprises for each node any of internal reset mechanisms and a reset pathway with one or more other nodes.

4. The apparatus of claim 1, wherein said fault tolerant processing scheme comprises any of the following mechanisms:
multiple processors having self contained operating systems;
redundant network links;
redundant power supplies;
redundant links to input/output devices;
distributed reset capability; and
software fault detection, adaptation, and recovery algorithms;
wherein said fault tolerance mechanisms also allow said system to continue functioning when components thereof are intentionally slowed, shut down, or subjected to a reduction in power supplied thereto.

5. The apparatus of claim 1, wherein a marginal temperature condition occurs when said temperature sensor detects an ambient temperature that is close to exceeding an operating range for said system or components thereof, and (optionally) that is rising.

6. The apparatus of claim 1, wherein said control mechanism shuts down said system to a minimal level of activity to allow for uninterrupted remote diagnostics and commands, as opposed to continuing service to users thereof.

7. The apparatus of claim 1, wherein said control mechanism slows system components by reducing a clock rate on individual chips or printed circuit boards.

8. The apparatus of claim 1, wherein said control mechanism shuts down system components by either of stopping software from running on processors and removing power from system components.

9. The apparatus of claim 1, wherein said control mechanism is operable at one or more selected levels of system integration that include any of said system, engines, nodes, and individual processors.

10. The apparatus of claim 1, wherein said control mechanism effects an orderly shutdown that comprises any of terminating software processes, flushing data to off-node memory or disks, removing chips from network routing tables, removing processors from job and object-manager tables, and notifying network operators of marginal temperature conditions and computer status.

11. The apparatus of claim 1, wherein said system operates in a temperature adaptation mode for any of a short interval of time to extended periods of time.

12. An apparatus for adapting system performance to variable ambient conditions, comprising:
a plurality of processing elements, each processing element in communication with at least one other processing element to effect a fault tolerant processing scheme;
an ambient condition sensor; and
a control mechanism responsive to said ambient condition sensor for any of slowing operation of, shutting down, or reducing power supplied to individual processing elements of said system in response to a said variable ambient conditions, as sensed by said ambient condition sensor;
wherein system performance is adapted to variable ambient conditions in response to said ambient condition sensor and said control mechanism.

13. The apparatus of claim 12, wherein said control mechanism intentionally degrades system performance by slowing down processor speed or disconnecting system elements, to address environmental stress due to an ambient temperature which exceeds recommended operating temperatures of said system.

14. The apparatus of claim 12, wherein said control mechanism shuts down a processing element by shutting down a corresponding power supply.

15. The apparatus of claim 12, wherein said control mechanism shuts down a processing element by shutting down corresponding memory and executing a halt on said processing element.

16. The apparatus of claim 12, wherein said control mechanism shuts down a processing element by putting said processing element into a state where it stops consuming power, but from which it cannot recover under normal operating conditions.

17. The apparatus of claim 12, wherein said control mechanism first instructs a processing element to be shut down to stop running any applications or transfer such functionality to a different processing elements if there are any jobs or applications running on said processing element that are critical before said processing element is shut down.

18. The apparatus of claim 12, wherein said control mechanism implements a restart mechanism to turn off a processing element without additionally turning said processing element back on.

19. The apparatus of claim 12, wherein said control mechanism implements any of temperature and power throttling when triggered by either of ambient temperature or current processing load.

20. The apparatus of claim 12, further comprising:
a logging and reporting function.

21. The apparatus of claim 12, wherein said control mechanism comprises:
a control processor that is responsible for issuing actions and requests with regard to slowing or shutting down system resources.

22. The apparatus of claim 12, wherein said control mechanism comprises:
a distributed function that is responsible for issuing actions and requests with regard to slowing or shutting down system resources.

23. A method for controlled degrading of system performance at marginal ambient temperatures, comprising the steps of:
providing a plurality of processing elements, each processing element in communication with at least one other processing element to effect a fault tolerant processing scheme;
providing a temperature sensor; and
providing a control mechanism responsive to said temperature sensor for any of slowing operation of, shutting down, or reducing power supplied to individual processing elements of said system in response to a marginal ambient temperature, as sensed by said temperature sensor;
wherein overall heat generated by said system is reduced.

24. The method of claim 23, wherein said control mechanism comprises for each node any of internal reset mechanisms and a reset pathway with one or more other nodes.

25. The method of claim 23, wherein said fault tolerant processing scheme comprises any of the following mechanisms:
multiple processors having self contained operating systems;
redundant network links;
redundant power supplies;
redundant links to input/output devices;
distributed reset capability; and
software fault detection, adaptation, and recovery algorithms;
wherein said fault tolerance mechanisms also allow said system to continue functioning when components thereof are intentionally slowed, shut down, or subjected to a reduction in power supplied thereto.

26. The methods of claim 23, wherein a marginal temperature condition occurs when said temperature sensor detects an ambient temperature that is close to exceeding an operating range for said system or components thereof, and (optionally) that is rising.

27. The method of claim 23, wherein said control mechanism shuts down said system to a minimal level of activity to allow for uninterrupted remote diagnostics and commands, as opposed to continuing service to users thereof.

28. The method of claim 23, wherein said control mechanism slows system components by reducing a clock rate on individual chips or printed circuit boards.

29. The method of claim 23, wherein said control mechanism shuts down system components by either of stopping software from running on processors and removing power from system components.

30. The method of claim 23, wherein said control mechanism effects an orderly shutdown that comprises any of terminating software processes, flushing data to off-node memory or disks, removing chips from network routing tables, removing processors from job and object-manager tables, and notifying network operators of marginal temperature conditions and computer status.

31. The method of claim 23, wherein said system operates in a temperature adaptation mode for any of a short interval of time to extended periods of time.

32. A method for adapting system performance to variable ambient conditions, comprising the steps of:
providing a plurality of processing elements, each processing element in communication with at least one other processing element to effect a fault tolerant processing scheme;
providing an ambient condition sensor; and
providing a control mechanism responsive to said ambient condition sensor for any of slowing operation of, shutting down, or reducing power supplied to individual processing elements of said system in response to a said variable ambient conditions, as sensed by said ambient condition sensor;
wherein system performance is adapted to variable ambient conditions in response to said ambient condition sensor and said control mechanism.

33. The method of claim 32, wherein said control mechanism intentionally degrades system performance by slowing down processor speed or disconnecting system elements, to address environmental stress due to an ambient temperature which exceeds recommended operating temperatures of said system.

34. The method of claim 32, wherein said control mechanism shuts down a processing element by shutting down a corresponding power supply.

35. The method of claim 32, wherein said control mechanism shuts down a processing element by shutting down corresponding memory and executing any of a halt, a wait, and an instruction with a similar effect on power conservation by said processing element.

36. The method of claim 32, wherein said control mechanism shuts down a processing element by putting said processing element into a state where it stops consuming power, but from which it cannot recover (without assistance of another processing element) under normal operating conditions.

37. The method of claim 32, wherein said control mechanism first instructs a processing element to be shut down to stop running any applications or transfer such functionality to a different processing elements if there are any jobs or applications running on said processing element that are critical before said processing element is shut down.

38. The method of claim 32, wherein said control mechanism implements a restart mechanism to turn off a processing element without additionally turning said processing element back on.

39. The method of claim 32, wherein said control mechanism implements any of temperature and power throttling when triggered by either of ambient temperature or current processing load.

40. The method of claim 32, further comprising the step of:
providing a logging and reporting function.

41. The method of claim 32, further comprising the step of:
providing a control processor that is responsible for issuing actions and requests with regard to slowing or shutting down system resources.

42. The method of claim 32, further comprising the step of:
providing a distributed function that is responsible for issuing actions and requests with regard to slowing or shutting down system resources.
